(19) United States
(12) Patent Application Publication
(10) Pub. No.: US 2006/0249596 A1
(43) Pub. Date: Nov. 9, 2006

(54) Pre-mixing torch device and method for optical fiber couplers

(76) Inventors: Cheng-Tsan Chou, Taipei (TW); Li-Ming Liou, Taipei (TW)

Correspondence Address: HARNESS, DICKEY & PIERCE, P.L.C., P.O. BOX 8910, RESTON, VA, 20195, US

(21) Appl. No.: 11/123,080

(22) Filed: May 6, 2005

(51) Int. Cl. B05B 1/28; C03B 37/028; F23D 11/10; B05B 1/14

(52) U.S. Cl. 239/290; 65/411; 239/423; 239/418; 239/548; 239/566

(57) ABSTRACT

A torch device and method for optical fiber couplers is provided to generate a high temperature flame. The apparatus includes air inlets to channel air, and a Venturi tube structure to increase the flow speed of a fuel gas to generate negative pressure to draw in air and accelerate mixing, so that the gas fuel and air are pre-mixed at a desired ratio to produce a high temperature flame. The bare portion of optical fibers may thus be heated rapidly to reach the desired fusion temperature.

### FIELD OF THE INVENTION

The invention relates to a heating apparatus and method, and particularly to a torch device and method for optical fiber couplers to generate a high temperature flame to rapidly heat a bare portion of optical fibers to the desired fusion temperature.

### BACKGROUND OF THE INVENTION

An optical fiber coupler is an element to split an optical signal of an optical fiber to multiple optical fibers. It also is called the splitter. It is widely used in user circuit systems, local area networks, optical cable TV networks and measurement systems. The most commonly used methods at present to couple or split the optical signal can be classified into three types, namely micro optics, fused biconical tapered and wave guide. The fused biconical tapered method is the mainstream for producing optical fiber couplers. It has about 85% of the market share.

Fabrication of the optical fiber coupler by means of the fused biconical tapered method involves bundling a plurality of optical fibers together, heating and fusing the optical fibers by a torch device, and stretching the optical fibers. After optical coupling is formed, the optical signal of one optical fiber can be evenly distributed to other optical fibers.

The design of the torch device is critical in this technique. In the past, in order to achieve the high temperature to fuse the optical fibers, heating was done by mixing oxygen with other fuel gas such as hydrogen, methane, propane or other volatile gases. However, dual-gas supply and mixing control are more complex. The equipment is also more expensive. Hence some torch apparatus use only a single fuel gas.

In the present techniques, the torch apparatus using a single fuel gas cannot provide a flame of high enough temperature due to lack of combustion-supporting gas such as the oxygen. The fusion temperature generally can reach only about 600-800° C. As a result, the optical fibers are not heated enough, and cannot be softened rapidly, or need a longer time to reach the required temperature. This seriously affects the production yield and speed of optical fiber couplers.

### SUMMARY OF THE INVENTION

The aforesaid problems occurring to the conventional techniques and torch devices are: difficulty in controlling supply and mixing of the combustion oxygen and fuel gas; expensive equipment; when adopted the torch device burning a single fuel gas, thermal power is inadequate, cannot reach the required fusion temperature, and needs longer heating time.

The primary object of the invention is therefore to provide a torch device for optical fiber couplers, that mainly includes a burner tube and a burner head. The burner tube has a fuel conduit and air inlets. The fuel conduit runs through the burner tube and is connected to a gas supply device to receive the fuel gas contained therein. The air inlets run through the side wall of the burner tube to draw the air into the fuel conduit to mix with the fuel gas. The burner head has a passage, a burner chamber and air vents. The passage has one end connecting to the fuel conduit to receive the fuel gas. The burner chamber is located on the other end of the passage. The air vents run through the inner wall of the burner head to channel the air into the furnace chamber to mix with the fuel gas for burning. Thereby the bare portion of a plurality of optical fibers can be heated to the fusion temperature and stretched as desired.

In another aspect, the torch device according to the invention further provides a fused biconical tapered method that includes the following steps: first, providing a fuel gas; next, providing air to pre-mix with the fuel gas; finally, burning the fuel gas and generating a flame of a desired temperature to fuse the bare portion of the plurality of optical fibers.

Because the invention adopts the approach of pre-mixing the air, the fuel gas can be burned more rapidly and generate a flame of higher temperature required in the fabrication process of the optical fiber couplers. The optical fibers can be heated to the desired temperature rapidly, and stretching of the optical fibers can be accomplished within a selected time period.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the torch device for optical fiber couplers of the invention installed on optical fiber coupler manufacturing equipment;

FIG. 2 is an exploded view of the torch device of the invention;

FIG. 3 is a sectional view of the burner tube of the invention;

FIG. 4 is a schematic view of the burner head of the invention; and

FIG. 5 is the main process flow chart of the fused biconical tapered method for optical fiber couplers of the invention.

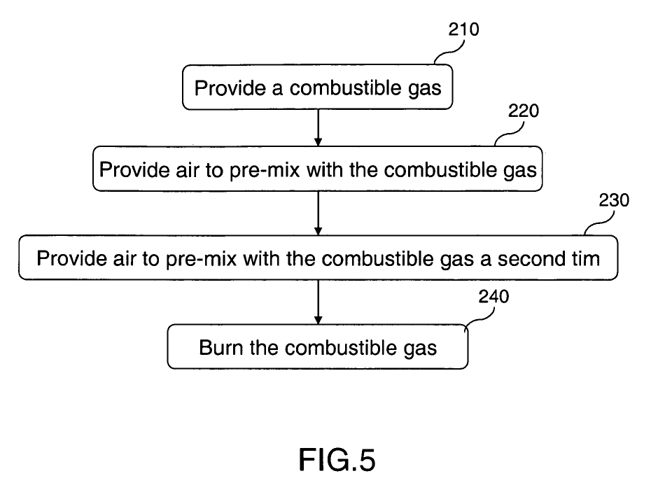

### DESCRIPTION OF THE PREFERRED EMBODIMENTS

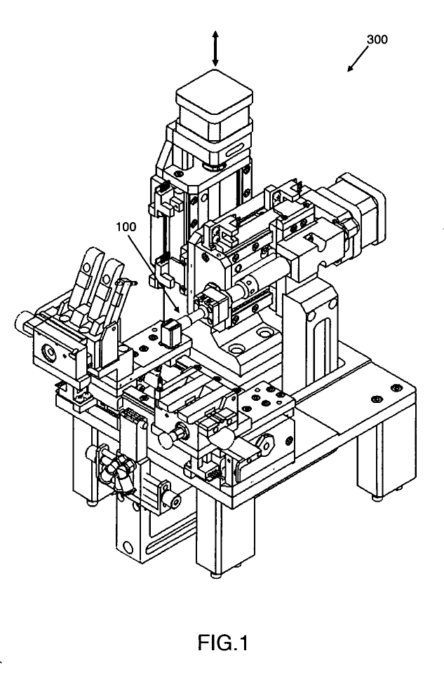

The torch device and method for optical fiber couplers provided by the invention are adopted on optical fiber coupler manufacturing equipment. Referring to FIG. 1, the torch device 100 according to the invention is installed on optical fiber coupler manufacturing equipment 300 to fuse a bare portion of optical fibers so that the optical fibers can be stretched to form optical coupling.

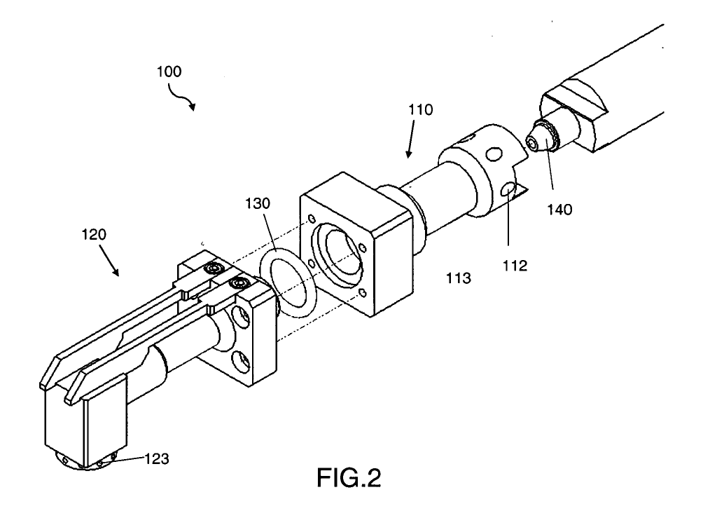

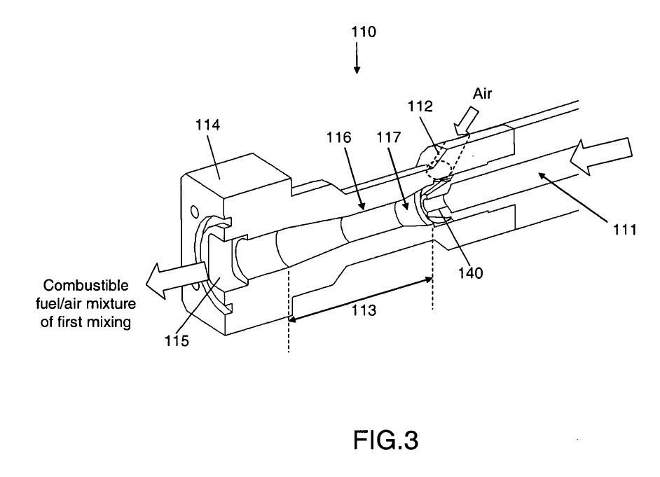

Referring to FIG. 2, the torch device 100 includes a burner tube 110 and a burner head 120. A an 0-ring 130 seals the interface between the burner tube 110 and the burner head 120. The main features of the invention include air inlets 112, a Venturi effect zone 113 (referring to FIG. 3), and air vents 123. Details are provided as follows.

Referring to FIGS. 2 and 3, the burner tube 110 is substantially a tubular structure. It has a fuel conduit 111. The air inlets 112 are formed on the periphery of a distal end of the fuel conduit 111 (on the right side in the drawings). The fuel conduit 111 runs through the burner tube 110, and is connected to a nozzle 140 on a distal end of the right side to connect to a gas supply device (not shown in the drawings) and receive the fuel gas contained therein. The fuel gas is volatile gas such as hydrogen, methane, propane or the like. The nozzle 140 is convergent to eject the fuel gas into the Venturi effect zone 113. The air inlets 112 run through the side wall of the burner tube 110. The axes of the air inlets 112 match the flow direction of the fuel gas, and are inclined relative to the axis of the fuel conduit 111. When the fuel gas is ejected into the Venturi effect zone 113, a convergent section 117 of the Venturi effect zone 113 generates negative pressure to draw the air into the fuel conduit 111 and form a first pre-mixing with the fuel gas. The burner tube 110 has a rectangular first connecting section 114 on a front end of the left side. The first connecting section 114 has a connecting surface that has a rectangular trough 115.

The Venturi effect zone 113 functions as a Venturi tube. The Venturi tube is a tubular structure that is convergent, then in parallel, and finally divergent. When a fluid passes through the portion of divergent, the flow speed decreases and the pressure increases. In the portion where the diameter is convergent, the flow speed increases while the pressure decreases. This is so called the Bernoulli Principle. Hence the fuel gas flowing in the convergent section 117 of the Venturi effect zone 113 has a higher speed and a lower pressure than the external pressure (namely a negative pressure), hence air is drawn into the fuel conduit 111 through the air inlets 112 to form a first pre-mixing in a mixing zone 116 of the Venturi effect zone 113. Without the Venturi effect zone 113, air intake will be not sufficient.

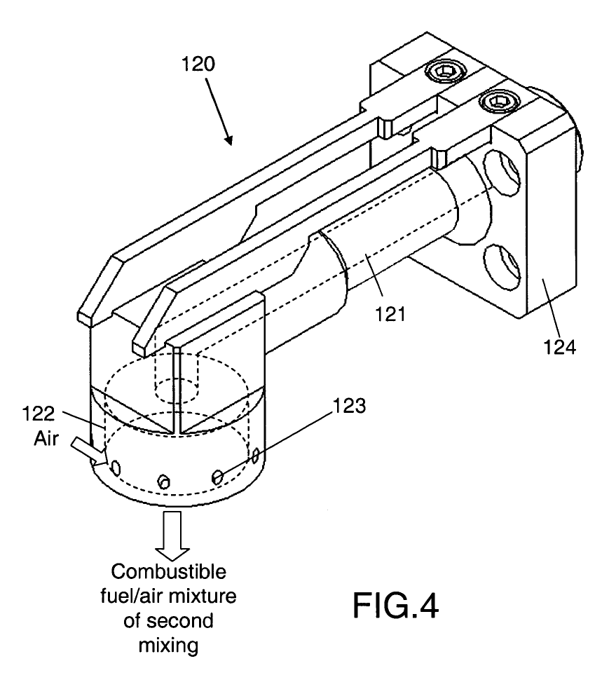

Referring to FIGS. 2 and 4, the burner head 120 is also substantially a tubular structure. It is bent downwards at a selected angle on a front end of the left side, and has a rectangular second connecting section 124 on a distal end of the right side mating the first connecting section 114 of the burner tube 110. The second connecting section 124 has a connecting surface that has a jutting member (not shown in the drawings) mating the wedge trough 115. The jutting member has a passage 121 with a rear end connecting tightly to the front end of the fuel conduit 111 of the wedge trough 115 so that the burner head 120 and the burner tube 110 may be coupled tightly. The passage 121 runs through the burner head 120 to receive the fuel gas through the fuel conduit 111. There is a burner chamber 122 on the front end of the passage 121 that has an inner diameter greater than the passage 121. The burner chamber has a plurality of air vents 123 that match the flow direction of the fuel gas, are inclined at a selected angle and run through the inner wall of the burner chamber 120 (the axes of the air vents 123 are inclined relative to the axis of the burner chamber 122). Thus the air may be drawn into the burner chamber 122 to mix with the fuel gas for a second time. Moreover, the burner head 120 may also have a Venturi effect zone (not shown in the drawings) to enhance the mixing effect.

By mixing with the air twice, burning of the fuel gas can reach a higher temperature. With hydrogen, for example, a temperature of 800° C. or more can be achieved. Although the invention does not use oxygen and uses only fuel gas, by pre-mixing with the air the fuel gas can get sufficient combustion oxygen and achieve the fusion temperature required to fabricate the optical fiber coupler.

The invention also provides a fused biconical tapered method to be used in the torch device. The process mainly includes the following steps:
(1) First, provide a fuel gas (step 210); this step ejects the fuel gas from the gas supply device to the burner tube.
(2) Next, provide air to pre-mix with the fuel gas (step 220); the air is channeled through the air inlets of the burner tube to mix with the fuel gas for the first time in the Venturi effect zone of the burner tube.
(3) Provide air to mix with the fuel gas one more time (step 230); air is channeled through the air vents of the burner head to mix with the fuel gas in the furnace chamber for a second time. This step is not mandatory if the fuel gas has mixed with enough air in the burner tube.
(4) Finally, burn the fuel gas (step 240) to heat the bare portion of the plurality of optical fibers to reach the desired fusion temperature and perform the stretching operation.

There is no limit to the number and locations of the air inlets and air vents. They can be formed on any location as long as the air can be drawn through the air inlets and air vents to mix with the fuel gas.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A torch device for optical fiber couplers, comprising:
a burner tube which has a fuel conduit and at least one air inlet, the fuel conduit running through the burner tube and being connected to a gas supply device to receive a fuel gas contained in the gas supply device and having a Venturi effect zone to accelerate flowing speed of the fuel gas, the air inlet running through a side wall of the burner tube to draw air into the fuel conduit and mix with the fuel gas; and
a burner head which has a passage, a burner chamber and at least one air vent, the passage having one end connecting to the fuel conduit of the burner tube to receive the fuel gas, the burner chamber being located on other end of the passage, the air vent running through an inner wall of burner head to draw the air into the burner chamber to mix with the fuel gas for burning thereby to heat a bare portion of a plurality of optical fibers to a fusion temperature for stretching.

2. The torch device of claim 1, wherein the fuel conduit of the burner tube is connected to a nozzle to draw the fuel gas from the gas supply device.

3. The torch device of claim 2, wherein the air inlet and the fuel conduit are joined close to the nozzle.

4. The torch device of claim 1, wherein the burner head further includes a Venturi zone.

5. The torch device of claim 1, wherein the axis of the air inlet is inclined relative to the axis of the fuel conduit.

6. The torch device of claim 1, wherein the axis of the air vent is inclined relative to the axis of the burner chamber.

7. The torch device of claim 1, wherein the passage has a distal end bending downwards for a selected angle.

8. The torch device of claim 1, wherein the fuel gas is hydrogen.

9. The torch device of claim 1, wherein the fuel gas is a volatile gas.

10. The torch device of claim 9, wherein the fuel gas is methane.

11. The torch device of claim 9, wherein the fuel gas is propane.

12. The torch device of claim 1, wherein the burner chamber has an inner diameter greater than the inner diameter of the passage.

13. A torch device for optical fiber couplers, comprising a burner tube and a burner head connecting to each other, the burner tube having a Venturi effect zone to connect to a gas supply device to draw a fuel gas to pass through the burner head, the burner tube and the burner head having at least one air inlet to draw air to mix with the fuel gas to be burned on one end of the burner head to heat a bare portion of a plurality of optical fibers to a fusion temperature for stretching.

14. The torch device of claim 13, wherein the burner head further includes a Venturi effect zone.

15. The torch device of claim 13, wherein the burner head is connected to a nozzle to draw the fuel gas from the gas supply device.

16. A fused biconical tapered method for optical fiber couplers, comprising the steps of:
A. providing a fuel gas;
B. providing air to pre-mix with the fuel gas; and
C. burning the fuel gas to provide required heat to heat a bare portion of a plurality of optical fibers to a fusion temperature for stretching.

17. The fused biconical tapered method of claim 16, wherein the fuel gas in the step A passes through a Venturi zone to increase flow speed.

18. The fused biconical tapered method of claim 16, wherein the fuel gas is mixed with the air again before proceeding the step C.
